(19) United States
(12) Patent Application Publication
(10) Pub. No.: US 2026/0092170 A1
(43) Pub. Date: Apr. 2, 2026

(54) ECO-FRIENDLY POLYPROPYLENE RESIN COMPOSITION WITH IMPROVED FRICTION AND WEAR CHARACTERISTICS AND SCRATCH RESISTANCE AND MOLDED ARTICLE MANUFACTURED THEREFROM

(71) Applicants: HYUNDAI MOBIS CO., LTD., Seoul (KR); HDC HYUNDAI ENGINEERING PLASTICS CO., LTD., Dangjin-si (KR)

(72) Inventors: Jin Won LEE, Yongin-si (KR); Geong Sun KIM, Yongin-si (KR); Eun Seob SHIN, Yongin-si (KR); Min Ho PARK, Yongin-si (KR); Chang Hee KANG, Seongnam-si (KR); Hyun Hoon KIM, Seongnam-si (KR); Sang Hyun LEE, Daejeon (KR); Ga Young KIM, Daejeon (KR)

(73) Assignees: HYUNDAI MOBIS CO., LTD., Seoul (KR); HDC HYUNDAI ENGINEERING PLASTICS CO., LTD., Dangjin-si (KR)

(21) Appl. No.: 19/339,947

(22) Filed: Sep. 25, 2025

(30) Foreign Application Priority Data
Sep. 30, 2024 (KR) 10-2024-0132512

(51) Int. Cl. C08L 23/12; C08K 3/30

(52) U.S. Cl. CPC C08L 23/12; C08K 3/30; C08K 2003/3045

(57) ABSTRACT

An eco-friendly polypropylene resin composition including 5 to 30 parts by weight of lignocellulose and 70 to 95 parts by weight of a polypropylene resin, based on 100 parts by weight of the polypropylene resin composition, and a molded article for automobile parts manufactured therefrom.

### CROSS REFERENCE TO RELATED APPLICATION

This application claims priority to and the benefit of Korean Patent Application No. 10-2024-0132512, filed on Sep. 30, 2024, the disclosure of which is incorporated herein by reference in its entirety.

### BACKGROUND

### 1. Field of the Invention

The present invention relates to an eco-friendly polypropylene resin composition including lignocellulose and a molded article for automobile parts manufactured therefrom and having improved friction and wear characteristics and scratch resistance.

### 2. Description of Related Art

In line with the demand for lighter automobiles to improve fuel efficiency and reduce carbon dioxide emissions, research is being actively conducted on low-density materials such as plastic materials to replace metal materials. Among these, a polypropylene resin is widely used as a material for automobile interior and exterior parts, electrical and home appliance parts, construction and industrial materials, films, pipes, and wires due to its excellent mechanical characteristics, moldability, and chemical resistance.

When a molded article manufactured by injection-molding such polypropylene resin is used as an automobile part, the fuel efficiency of the automobile can be improved due to the weight reduction of the part, and the polypropylene resin can lower manufacturing costs and has the advantage of being easy to recycle.

In the past, when using polypropylene materials for automobile interior and exterior parts, talc has been widely used as an inorganic filler to ensure excellent mechanical properties and appearance quality. Korean Patent Registration No. 10-0541496 and Korean Patent Publication No. 10-2024-0111056 disclose polypropylene resin compositions including talc.

However, as the talc content increases, the mechanical characteristics and heat resistance improve, but there is a disadvantage in that the molded article has low resistance to external scratches due to high whiteness and low inherent hardness. In other words, when talc is used at a high content, the appearance becomes rough and the surface hardness and scratch resistance deteriorate. Therefore, in products that prioritize appearance, such as automobile interior materials or interior household goods that use talc-filled polypropylene resin, there is a problem of increased costs because separate additives must be added or scratch resistance must be improved through a painting process.

For example, the polypropylene resin, which is mainly used in automobile parts, is often made with high talc content (20% or more), which results in poor scratch resistance. In order to secure the scratch resistance of these high-content talc products, additional rubber, silicone compounds, fluororesin, and amide-based additives were used to supplement this, but it is difficult to secure a certain level of scratch resistance and there is a disadvantage in that the stain resistance is low.

In particular, most of these additive ingredients are made from petroleum-based materials and can worsen environmental pollution problems, which runs counter to climate change and carbon neutrality. Accordingly, there is a need for the development of eco-friendly materials that can improve scratch resistance from biomass.

### SUMMARY

The present invention is directed to providing a polypropylene composition with improved wear resistance, friction resistance, and scratch resistance, which is applicable to automobile interior and exterior materials.

The present invention is also directed to providing an eco-friendly polypropylene composition that introduces a lignocellulosic biomass material as a filler.

One aspect of the present invention provides an eco-friendly polypropylene resin composition including 5 to 30 parts by weight of lignocellulose and 70 to 95 parts by weight of a polypropylene resin, based on 100 parts by weight of the polypropylene resin composition.

According to an embodiment, the lignocellulose may have a ratio of lignin and cellulose ranging from 3:7 to 7:3.

According to an embodiment, the lignocellulose may further include one or more metal salts selected from CaSO₄, Na₂SO₄, K₂SO₄, and MgSO₄.

According to an embodiment, a particle size of the lignocellulose may be in a range of 0.5 μm to 100 μm, preferably in a range of 3 μm to 40 μm.

According to an embodiment, a density of the lignocellulose may be in a range of 1.1 to 1.5.

According to an embodiment, the polypropylene resin may be a polypropylene homopolymer, a propylene-ethylene copolymer, or a mixture thereof.

According to an embodiment, the eco-friendly polypropylene resin composition may further include one or more additives selected from an antioxidant, a filler, an antistatic agent, a lubricant, and a slip agent.

Another aspect of the present invention provides a molded article for automobile parts manufactured using the eco-friendly polypropylene resin composition.

The molded article may have a ΔL value ranging from 2.5 to 6.5 as a result of the Erichsen scratch resistance evaluation according to the KS B 0182 test method.

The molded article may have an average friction coefficient ranging from 0.1 to 0.2 and an average frictional force ranging from 13 to 17.5, as measured according to the ASTM G99-23 standard.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an SEM photograph of lignocellulose;

FIGS. 2 and 3 are photographs showing the results of scratch resistance evaluation of molded articles according to examples and comparative examples; and

FIGS. 4 and 5 are graphs showing the results of friction and wear evaluation of molded articles according to changes in filler content in the examples and comparative examples.

### DETAILED DESCRIPTION

Hereinafter, the present invention will be described in more detail with reference to embodiments and drawings. However, the following embodiments are provided by way of example to help the understanding of the present invention, and the scope of the present invention is not limited thereto. It should be understood that the present invention can be modified in various ways and can be embodied in many different forms, and all modifications, equivalents and substitutes are included in the spirit and scope of the present invention.

The terms used in the present application are only used to describe specific embodiments, and are not intended to limit the present invention. Singular expressions include plural expressions unless the context clearly dictates otherwise. In the present application, it is to be understood that the terms “include(s)” or “have (has)” and the like are intended to specify the presence of stated features, numbers, steps, operations, components, parts or combinations thereof, but do not preclude the presence or addition of one or more other features, numbers, steps, operations, components, parts and combinations thereof.

Unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with its meaning in the context of the related art and should not be interpreted in an ideal or excessively formal meaning unless explicitly defined in the present application.

The present invention relates to an eco-friendly polypropylene resin composition including lignocellulose, which is a biomass material, and a molded article for automobile parts manufactured therefrom and having improved friction and wear characteristics and scratch resistance.

An eco-friendly polypropylene resin composition according to an embodiment is characterized by including 5 to 30 parts by weight of lignocellulose and 70 to 95 parts by weight of a polypropylene resin, based on 100 parts by weight of the polypropylene resin composition.

Hereinafter, each component and content of the polypropylene resin composition will be described in detail.

### 1) Polypropylene Resin

Polypropylene resin, which is a lightweight polymer with excellent mechanical characteristics, moldability, and processability, may be used as a base resin for the eco-friendly resin composition.

The polypropylene resin may be selected from a polypropylene homopolymer, a propylene-ethylene copolymer, or a mixture thereof. For example, when the polypropylene resin is an ethylene-propylene copolymer, it may include about 5% to about 10% by weight of ethylene.

According to an embodiment, the polypropylene resin may be included in an amount of about 70 to 95 parts by weight, and more preferably 80 to 90 parts by weight, based on 100 parts by weight of the eco-friendly polypropylene resin composition including lignocellulose.

When the polypropylene resin is included in an amount in the above range in a polypropylene resin composition with improved scratch resistance, it is possible to reduce costs and impart excellent processability, and when lignocellulose, a biomass filler, is included in the composition, it is possible to impart excellent mechanical strength and impact resistance.

The polypropylene resin may be a highly crystalline ethylene-propylene copolymer resin having an isotactic index of about 97 to about 99, and may impart excellent rigidity and heat resistance.

In addition, the polypropylene resin has a melt index of about 10 g/10 min to 30 g/10 min measured at a temperature of 230° C. and a load of 2.16 kg, thereby providing excellent molding processability along with excellent mechanical rigidity and impact resistance.

In addition, since the polypropylene resin has a molecular weight distribution (weight average molecular weight/number average molecular weight, polydispersity index) of 3 to 7, specifically, a molecular weight distribution of about 4 to 6, it may impart excellent processing effects along with excellent mechanical properties and good moldability.

### 2) Lignocellulose

The polypropylene resin composition according to an embodiment of the present invention is characterized by the use of lignocellulose, which is a biomass material, as a filler.

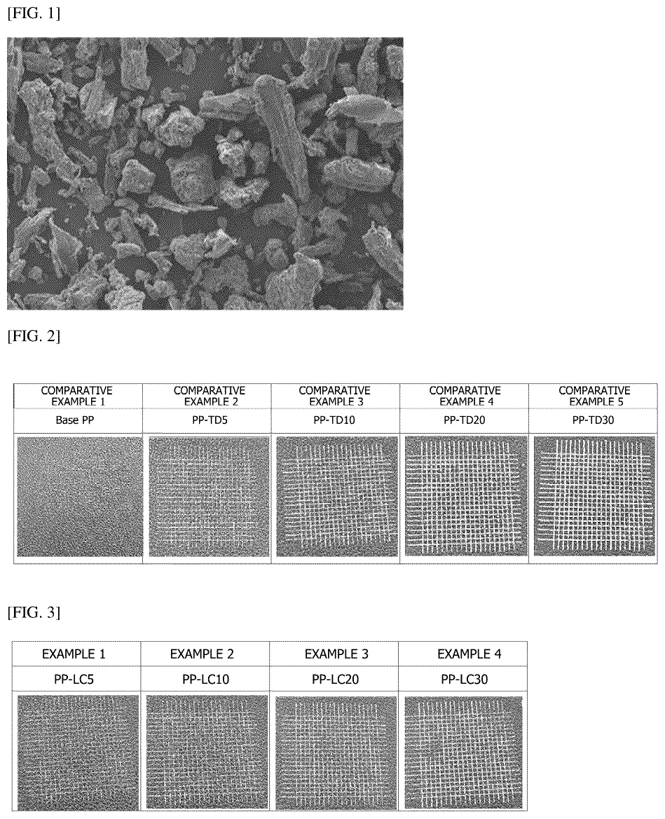

FIG. 1 shows an SEM photograph of lignocellulose. Lignocellulose is a biomass material that is a mixture of lignin and cellulose, and generally has a black-brown color. It is desirable to prepare lignocellulose by utilizing inedible, unused wood (waste wood). Methods of preparing lignocellulose include, but are not particularly limited to, the method disclosed in Korean Patent Registration No. 10-2660285.

Lignocellulose used as a filler in the eco-friendly propylene resin composition according to the present invention is preferably a mixture of lignin and cellulose in a ratio of 3:7 to 7:3. When a lignin content exceeds the above range, there is a problem of odor generation during the process of preparing a polypropylene composite resin, and when a cellulose content exceeds the above range, there is a disadvantage of reduced mechanical strength due to low dispersibility within the polypropylene resin. Therefore, it is suitable to use lignocellulose, which is a mixture of lignin and cellulose in the above ratio.

In addition, the lignocellulose may further include one or more metal salts selected from CaSO₄, Na₂SO₄, K₂SO₄, and MgSO₄, and among these, it is desirable to include calcium sulfate (CaSO₄).

Adding metal salts can increase the dimensional stability of plastic parts. For example, a mixing ratio of calcium sulfate (CaSO₄) based on 100 parts by weight of lignocellulose is preferably 5 to 25 parts by weight. When the mixing ratio of calcium sulfate is less than the above range, there is a problem that the dimensional stability of the plastic is lowered, requiring the use of additional inorganic fillers, and when it exceeds the above range, there is a problem that the weight of the plastic part increases due to the high specific gravity of CaSO₄.

In addition, a particle size of lignocellulose used as a biomass filler of the polypropylene resin composition may range from 0.5 μm to 100 μm, preferably from 3 to 40 μm. When the size of the lignocellulose particles is less than the above range, there is a problem of reduced workability, such as generation of fine dust and difficulty in inputting into an extruder during the process of preparing a polypropylene composite resin, and when the size exceeds the above range, there is a problem of the mechanical properties of the polypropylene composite resin being degraded.

A density of the usable lignocellulose may range from 1.1 to 1.5, a decomposition temperature of the cellulose is 250° C. or higher, a moisture content is less than 5%, and a pH is 6 to 8. In terms of density, the polypropylene composite resin may be made lighter due to its density being half that of existing inorganic fillers, and since a processing temperature of the polypropylene composite resin is 250° C. or lower when the thermal decomposition temperature is 250° C. or higher, surface defects due to thermal decomposition may be prevented. In addition, the moisture content of less than 5% prevents surface defects caused by moisture during polypropylene composite resin processing.

### 3) Eco-Friendly Polypropylene Resin Composition

The eco-friendly polypropylene resin composition according to an embodiment of the present invention includes 5 to 30 parts by weight of lignocellulose and 70 to 95 parts by weight of a polypropylene resin.

When a content of lignocellulose is less than 5 parts by weight, the friction and wear characteristics and scratch resistance are poorly improved, and when it exceeds 30 parts by weight, there may be problems with moisture absorption and dispersibility, and physical properties such as impact strength and rigidity may be significantly reduced. Therefore, a content of lignocellulose based on 100 parts by weight of the resin composition is appropriately 5 to 30 parts by weight, and more preferably 20 to 30 parts by weight.

According to the present invention, the eco-friendly polypropylene resin composition with improved scratch resistance may further include one or more additives selected from a compatibilizer, a slip agent, an antioxidant, a light stabilizer, an antistatic agent, and a lubricant, depending on its purpose. The additive may be used in an amount ranging from 0.1 to 5 parts by weight based on 100 parts by weight of the polypropylene resin composition.

The compatibilizer is intended to improve the compatibility between the filler and the polypropylene resin, and may impart excellent mechanical rigidity and impact resistance by increasing the compatibility, and simultaneously impart dimensional stability.

Specifically, the compatibilizer is a modified polyolefin resin including a reactive group reactive with an inorganic filler at the main chain or terminal of the polyolefin, and examples of the reactive group include maleic acid, maleic anhydride, carboxylic acid, hydroxyl groups, vinyl acetate, glycidyl methacrylate, vinyloxazoline, acrylic acid, and the like.

A content of the compatibilizer may be 0.1 to 3 parts by weight based on 100 parts by weight of the polypropylene resin composition, which may improve the compatibility between the filler and the resin, thereby improving the degree of dispersion, thereby imparting excellent mechanical rigidity and impact resistance, and simultaneously imparting dimensional stability.

The slip agent may be one selected from the group consisting of a siloxane-based slip agent, an amide-based slip agent, and a combination thereof, which enhances lubricity during molding of the polypropylene resin composition with improved scratch resistance.

The antioxidant may be one selected from the group consisting of a phenolic antioxidant, a phosphite-based antioxidant, thiodipropionate, and a combination thereof.

According to an embodiment, a molded article manufactured using the eco-friendly polypropylene resin composition exhibited excellent scratch resistance characteristics. Specifically, a ΔL value may range from 2.5 to 6.5 as a result of the Erichsen scratch resistance evaluation according to the KS B 0182 test method.

In addition, a molded article manufactured using the eco-friendly polypropylene resin composition had an average friction coefficient of 0.1 to 0.2 and an average frictional force of 13 to 17.5, as measured according to the ASTM G99-23 test method, satisfying all applicable standards for automobile parts, and the like.

In this way, the polypropylene resin composition according to the present invention can help solve environmental problems by reducing carbon emissions, which cause climate change, by including a high content of lignocellulose, a biomass material, and is suitable for manufacturing automobile parts as a lightweight material with excellent scratch resistance and mechanical characteristics. Specific examples of automobile interior or exterior parts to which the eco-friendly polypropylene resin composition according to the present invention may be applied include glove boxes, defrost nozzles, center housings, lamp housings, bumpers, instrument panels, door trims, and the like, and are useful for parts requiring a high level of scratch resistance.

### EXAMPLES AND COMPARATIVE EXAMPLES

The lignocellulose shown in Table 1 below was used as a filler in a polypropylene resin composition. In lignocellulose (LC), a lignin and cellulose mixing ratio was 7:3, and lignocellulose containing 5% of CaSO4 was used (manufacturer: Lignum, product name: SSEIF-L).

TABLE 1

| Items | Physical properties | |
|---|---|---|
| Composition | Lignin + cellulose + CaSO₄ | |
| Density | 1.2 | |
| Particle refractive index | 1.52 | |
| Color | Dark brown | |
| Decomposition temperature | 250° C. or higher | |
| Moisture content | Less than 5% | |
| pH | 6 to 8 | |
| Specific surface area | 727 | m²/kg |
| Particle size Dv(10) | 3.46 | μm |
| Particle size Dv(50) | 14.7 | μm |
| Particle size Dv(90) | 36.9 | μm |

The above lignocellulose (LC) was used to prepare polypropylene resin compositions of examples and comparative examples according to the compositions in Tables 2 and 3 below. In Examples 1 to 4, polypropylene resin compositions including 5%, 10%, 20%, and 30% of lignocellulose (LC) were prepared, and in Comparative Example 1, a highly crystalline polypropylene resin having a crystallinity in the range of 60±10% was used, and in Comparative Examples 2 to 5, polypropylene resin compositions including 5%, 10%, 20%, and 30% of talc (TD) were prepared. Highly crystalline polypropylene is suitable for use in eco-friendly polypropylene resin compositions because it may prepare high-rigidity resin compositions that satisfy the mechanical properties required for automobile interior and exterior materials.
Polypropylene resin: Highly crystalline polypropylene (crystallinity: 60±10%)
Lignocellulose (LC): Lignin and cellulose mixing ratio of 7:3, containing 5% of CaSO4 (manufacturer: Lignum, product name: SSEIF-L)
Talc (TD)

TABLE 2

| | Example 1 | Example 2 | Example 3 | Example 4 |
|---|---|---|---|---|
| | PP-LC5 | PP-LC10 | PP-LC20 | PP-LC30 |
| TD content (%) | 0 | 0 | 0 | 0 |
| LC content (%) | 5 | 10 | 20 | 30 |

TABLE 3

| | Comparative | Comparative | Comparative | Comparative | Comparative |
|---|---|---|---|---|---|
| | Example 1 | Example 2 | Example 3 | Example 4 | Example 5 |
| | Base PP | PP-TD5 | PP-TD10 | PP-TD20 | PP-TD30 |
| TD content (%) | 0 | 5 | 10 | 20 | 30 |
| LC content (%) | 0 | 0 | 0 | 0 | 0 |

### <Test Example 1> Basic Property Evaluation

After preparing specimens using the polypropylene resin compositions prepared according to the above examples and comparative examples, their basic properties and performance were measured, and the results are shown in [Table 4].

MI decreased as the LC content increased, and the density was below 1 up to PP-LC20 in which the LC content was 20%. In addition, as the LC content increased, the tensile strength, elongation, and IZOD impact strength slightly decreased, but the flexural modulus, flexural strength, and HDT improved as the LC content increased.

TABLE 4

| | | Test method | Example 1 | Example 2 | Example 3 | Example 4 |
|---|---|---|---|---|---|---|
| Material composition | | — | PP-LC5 | PP-LC10 | PP-LC20 | PP-LC30 |
| MI (g/10 min) | | ISO 1133 | 25.2 | 25.1 | 19.5 | 13.6 |
| Density | | ISO 1183 | 0.926 | 0.943 | 0.980 | 1.017 |
| Tensile strength (MPa) | | ISO 527 | 29.9 | 28.9 | 26.6 | 24.2 |
| Elongation (%) | | | 63 | 33 | 18 | 11 |
| Flexural modulus (MPa) | | ISO 178 | 1.858 | 1.963 | 2.265 | 2.488 |
| Flexural strength (MPa) | | | 49.0 | 48.9 | 47.5 | 44.2 |
| IZOD | 23° C. | ISO 180 | 3.6 | 3.3 | 2.9 | 1.5 |
| impact | −10° C. | TYPE A | 2.9 | 2.8 | 1.7 | 1.8 |
| strength | | | | | | |
| (kJ/m²) | | | | | | |

| | | | | | |
|---|---|---|---|---|---|
| HDT (° C.), 0.45 MPa | ISO 75 | 119.8 | 130.5 | 137.5 | 141.3 |

### <Test Example 2> Scratch Resistance Evaluation

After molding the polypropylene resin compositions of the above examples and comparative examples to prepare specimens, scratch resistance characteristics were evaluated by scratching 20 or more grid patterns at 2 mm intervals under the evaluation conditions shown in [Table 5] below, measuring the L values before and after the scratch evaluation, and calculating the ΔL value in accordance with the Erichsen test method and KS B 0812.

TABLE 5

| Classification | Classification | Conditions |
|---|---|---|
| Evaluation equipment | Load (N) | 10 |
| | Scratch length (mm) | 40 |
| | Spacing (mm) | 2 |
| | Scratcher | φ1 |
| | Number of scratches (times) | 20 (width/height) |
| Measuring equipment | Light source | D65 |
| | Measurement method | d/8 (spin sphere) |

The measurement results of the scratch resistance characteristics, the ΔL value, of the polypropylene resin molded articles of the examples and comparative examples evaluated by the above Erichsen test method are shown in [Table 6], [Table 7], FIG. 2, and FIG. 3 below. As shown in the measurement results of the ΔL value and the scratch photographs in the drawings, it can be confirmed that the scratch resistance of the polypropylene resin molded articles is significantly improved as the content of lignocellulose (LC) increases in the examples compared to the increase in the content of talc (TD) in the comparative examples.

TABLE 6

| | Comparative | Comparative | Comparative | Comparative | Comparative |
|---|---|---|---|---|---|
| Scratch resistance | Example 1 | Example 2 | Example 3 | Example 4 | Example 5 |
| Erichsen | Base PP | PP-TD5 | PP-TD10 | PP-TD20 | PP-TD30 |
| evaluation | | | | | |
| ΔL | 1.02 | 3.5 | 6.46 | 10.99 | 12.46 |

TABLE 7

| Scratch resistance | Example 1 | Example 2 | Example 3 | Example 4 |
|---|---|---|---|---|
| Erichsen | PP-LC5 | PP-LC10 | PP-LC20 | PP-LC30 |
| evaluation | | | | |
| ΔL | 2.86 | 3.68 | 4.56 | 6.07 |

### <Test Example 3> Evaluation of Friction and Wear Characteristics

After molding the polypropylene resin compositions of the above examples and comparative examples to prepare specimens, their friction and wear characteristics were evaluated. The friction and wear evaluation was conducted by applying the counterpart material SUJ2, a load of 100 N, a speed of 1 Hz, a stroke of 10 mm, and a time of 1 hour according to the ASTM G99-23 test method to measure the average friction coefficient, average frictional force, and wear depth.

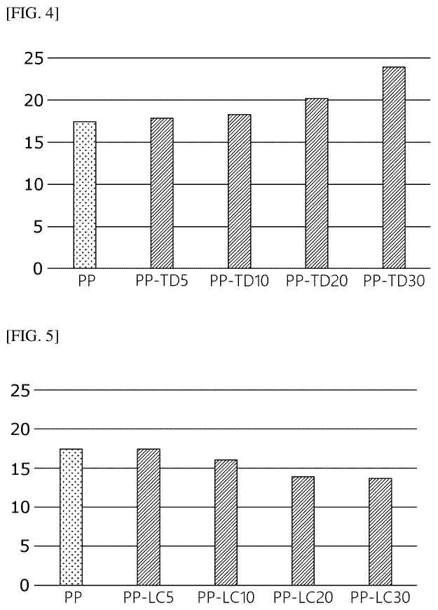

As a result of the friction and wear evaluation, as shown in [Table 8], [Table 9], and FIGS. 4 and 5, it was confirmed that as the talc (TD) content increased, the frictional force and wear depth increased, and as the lignocellulose (LC) content increased, the frictional force and wear depth decreased. In particular, it can be seen that the friction and wear resistance of a polypropylene resin composition having a lignocellulose (LC) content of 10% or more is excellent.

TABLE 8

| Friction and wear | Comparative | Comparative | Comparative | Comparative | Comparative |
|---|---|---|---|---|---|
| evaluation | Example 1 | Example 2 | Example 3 | Example 4 | Example 5 |
| Material composition | Base PP | PP-TD5 | PP-TD10 | PP-TD20 | PP-TD30 |
| Surface roughness | 0.05 | 0.05 | 0.05 | 0.05 | 0.08 |
| (Ra, μm) | | | | | |
| Average friction | 0.177 | 0.182 | 0.188 | 0.206 | 0.245 |
| coefficient | | | | | |
| Average frictional | 17.5 | 18 | 18.5 | 20.3 | 24.1 |
| force | | | | | |
| Wear depth (mm) | 0.0562 | 0.0687 | 0.0717 | 0.11 | 0.1419 |

TABLE 9

| Friction and wear | | | | |
|---|---|---|---|---|
| evaluation | Example 1 | Example 2 | Example 3 | Example 4 |
| Material composition | PP-LC5 | PP-LC10 | PP-LC20 | PP-LC30 |
| Surface roughness | 0.05 | 0.06 | 0.08 | 0.27 |
| (Ra, μm) | | | | |
| Average friction | 0.175 | 0.162 | 0.141 | 0.136 |
| coefficient | | | | |
| Average frictional | 17.4 | 16.1 | 14.0 | 13.6 |
| force | | | | |
| Wear depth (mm) | 0.0532 | 0.0267 | 0.0081 | 0.0080 |

In this way, it can be seen that the polypropylene resin composition including lignocellulose as a filler according to the present invention is an eco-friendly, lightweight material with excellent scratch resistance and friction and wear resistance, and is suitable for manufacturing automobile interior and exterior parts.

A polypropylene composition according to the present invention is an eco-friendly resin composition including lignocellulose, which is a biomass material, as a filler, and can reduce the environmental burden by achieving carbon neutrality.

In addition, since the eco-friendly polypropylene resin composition including lignocellulose has good mechanical characteristics and excellent scratch resistance, it can replace talc materials that cause clouding and have poor scratch resistance.

Specifically, the molded article manufactured using the eco-friendly polypropylene resin composition including lignocellulose according to the embodiment has a ΔL value ranging from 2.5 to 6.5 as a result of the Erichsen scratch resistance evaluation according to the KS B 0182 test method, and has an average friction coefficient ranging from 0.1 to 0.2 and an average frictional force ranging from 13 to 17.5, as measured according to the ASTM G99-23 standard, indicating high potential for use in automobile interior or exterior parts.

Effects of the present invention are not limited to the effects mentioned above, and other effects not mentioned will be clearly understood by those skilled in the art from the description above.

From the above description, those of ordinary skill in the art to which the present invention pertains will understand that the present invention may be embodied in other specific forms without changing the technical spirit or essential features thereof. In this regard, it should be understood that the embodiments described above are illustrative in all respects and not restrictive. The scope of the present invention should be interpreted as including within the scope of the present invention all changes or modifications derived from the meaning and scope of the patent claims described below and their equivalent concepts, rather than the detailed description above.

What is claimed is:

1. An eco-friendly polypropylene resin composition, comprising:
5 to 30 parts by weight of lignocellulose; and
70 to 95 parts by weight of a polypropylene resin, based on 100 parts by weight of the polypropylene resin composition.

2. The eco-friendly polypropylene resin composition of claim 1, wherein the lignocellulose has a ratio of lignin and cellulose in a range of 3:7 to 7:3.

3. The eco-friendly polypropylene resin composition of claim 1, wherein the lignocellulose further includes one or more metal salts selected from CaSO₄, Na₂SO₄, K₂SO₄, and MgSO₄.

4. The eco-friendly polypropylene resin composition of claim 1, wherein the lignocellulose has a particle size ranging from 0.5 μm to 100 μm.

5. The eco-friendly polypropylene resin composition of claim 1, wherein the lignocellulose has a density ranging from 1.1 to 1.5.

6. The eco-friendly polypropylene resin composition of claim 1, wherein the polypropylene resin is a polypropylene homopolymer, a propylene-ethylene copolymer, or a mixture thereof.

7. The eco-friendly polypropylene resin composition of claim 1, further comprising one or more additives selected from a compatibilizer, a slip agent, an antioxidant, a light stabilizer, an antistatic agent, and a lubricant.

8. A molded article for automobile parts manufactured by molding the eco-friendly polypropylene resin composition of claim 1.

9. The molded article of claim 8, wherein a ΔL value ranges from 2.5 to 6.5 as a result of the Erichsen scratch resistance evaluation according to the KS B 0182 test method.

10. The molded article of claim 8, wherein the molded article has an average friction coefficient ranging from 0.1 to 0.2 and an average frictional force ranging from 13 to 17.5, as measured according to the ASTM G99-23 test method.
